(19) United States
(12) Patent Application Publication
(10) Pub. No.: US 2013/0144709 A1
(43) Pub. Date: Jun. 6, 2013

(54) COGNITIVE-IMPACT MODELING FOR USERS HAVING DIVIDED ATTENTION

(71) Applicants: Nitya Narasimhan, Hopewell Junction, NY (US); Venugopal Vasudevan, Palatine, IL (US); Joseph F. Wodka, Hoffman Estates, IL (US)

(72) Inventors: Nitya Narasimhan, Hopewell Junction, NY (US); Venugopal Vasudevan, Palatine, IL (US); Joseph F. Wodka, Hoffman Estates, IL (US)

(73) Assignee: GENERAL INSTRUMENT CORPORATION, Horsham, PA (US)

(21) Appl. No.: 13/310,854

(22) Filed: Dec. 5, 2011

(51) Int. Cl. G06F 3/048; G06Q 30/02

(52) U.S. Cl. 705/14.41; 715/733

(57) ABSTRACT

Systems and methods are provided for modeling the cognitive impact of content displayed on a first device on a user engaged with a second device. An exemplary method involves obtaining activity by the user associated with the second device when content is displayed on the first device, determining an impact metric for the content, and correlating the impact metric with the user activity for the user. In another embodiment, an exemplary content-management system includes a campaign-management system to provide content displayed on a first device and an impact-modeling system to capture user activity on a second device when the content is displayed on the first device, determine an impact metric for the content, and correlate the impact metric to the user activity for the user.

### FIELD OF THE INVENTION

Embodiments of the subject matter described herein relate generally to electronic devices, and, more particularly, embodiments of the subject matter relate to determining the relationship between the cognitive impact of content presented on one device with respect to user activity on a second device.

### BACKGROUND OF THE INVENTION

In recent years, the widespread deployment and development of consumer electronic devices have provided users with an increasing number of options for consuming content and accessing services. For example, an individual user may own or otherwise utilize a television, a desktop computer, a portable (or mobile) computer, a mobile phone (or smartphone), and a portable media player. Thus, at any given time, the user may have access to a number of electronic devices capable of providing content or services to the user. Oftentimes, a user will multitask or otherwise divide his attention across multiple electronic devices. For example, a user may check e-mail on one device while watching television. Thus, there is uncertainty not only as to whether or not users are paying attention to content presented on a particular device, but also uncertainty as to what effect the presented content had on a user whose attention is divided across additional devices. This poses a problem, particularly for advertisers, when trying to determine what effect content presented on one device (e.g., a television) has on users who are concurrently engaged in activities on other electronic devices.

### BRIEF DESCRIPTION OF THE DRAWINGS

A more complete understanding of the subject matter may be derived by referring to the detailed description and claims when considered in conjunction with the following figures, wherein like reference numbers refer to similar elements throughout the figures.

FIG. 1 is a block diagram of an exemplary electronic device in accordance with one embodiment;

FIG. 2 is a block diagram of an exemplary content-management system in accordance with one embodiment;

FIG. 3 is a flow diagram of a cognitive-impact modeling process suitable for use with the content-management system of FIG. 2 in accordance with one or more embodiments; and

FIG. 4 is a diagram illustrating communications within the content-management system of FIG. 2 in accordance with an exemplary embodiment of the cognitive-impact modeling process of FIG. 3.

### DETAILED DESCRIPTION

The following detailed description is merely illustrative in nature and is not intended to limit the embodiments of the subject matter or the application and uses of such embodiments. Any implementation described herein as exemplary is not necessarily to be construed as preferred or advantageous over other implementations. Furthermore, there is no intention to be bound by any expressed or implied theory presented in the preceding technical field, background, or the following detailed description.

Embodiments of the subject matter described herein relate to correlating the cognitive impact of content displayed or otherwise presented on one device to user activity associated with a second device. As described in greater detail below, activity concurrently being performed by a user on the second device is automatically (i.e., without or otherwise independent of any manual input or other manual intervention) captured when content is displayed by the first device. A cognitive-impact metric indicative of the effect that the content that was displayed by the first device had on the user is determined, and, based on the cognitive-impact metric and the captured user activity, a cognitive-impact model for the user may be constructed that correlates user activity on the second device with the cognitive impact of content presented on the first device on that user. As described in greater detail below, the cognitive-impact model may be used to select or otherwise determine content to be presented to the user on the first device based on the current activity being performed by the user on the second device prior to presenting additional content on the first device. Although the subject matter may be described herein in the context of advertising content (or advertisements), it will be appreciated that the subject matter is not limited to any particular type of content being analyzed and correlated to concurrent user activity.

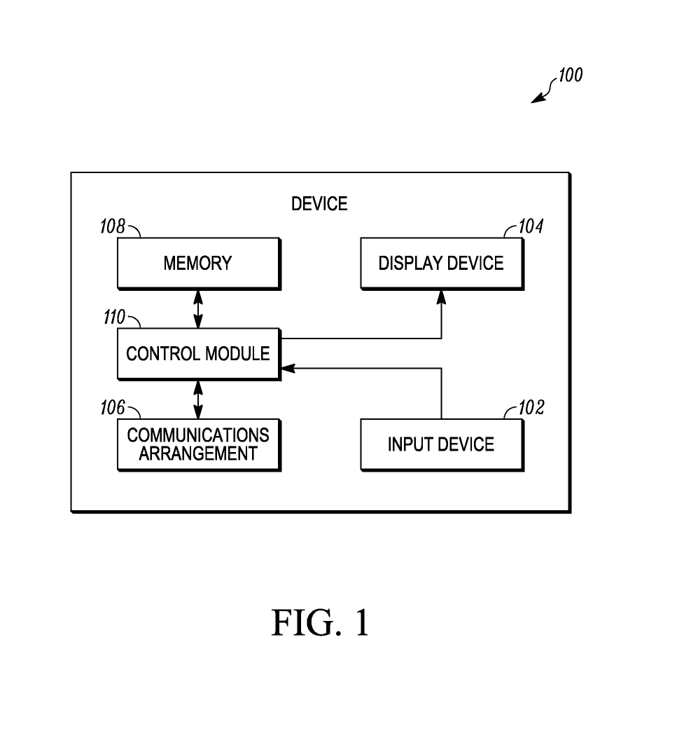

Turning now to FIG. 1, in an exemplary embodiment, an electronic device 100 (or a combination thereof) is capable of performing or otherwise supporting one or more of the processes, tasks, or functions described herein. Depending on the embodiment, the electronic device 100 may be realized as a television, a mobile communications device (e.g., a cellular phone, smartphone, or the like), a computer (e.g., a desktop computer, a laptop computer, a tablet, a personal digital assistant, or the like), a server, a set top box, or another suitable electronic device capable of performing or otherwise supporting the cognitive-impact modeling process 300 described herein. In an exemplary embodiment, the electronic device 100 includes, without limitation, an input device 102, a display device 104, a communications arrangement 106, a memory 108, and a control module 110. It should be understood that FIG. 1 is a simplified representation of an electronic device 100 for purposes of explanation and is not intended to limit the scope of the subject matter in any way.

In the illustrated embodiment, the input device 102 generally represents the hardware, software, firmware, or combinations thereof configured to provide a user interface with the electronic device 100. Depending on the embodiment, the input device 102 may be realize as a key pad, a keyboard, one or more buttons, a touch panel, a touchscreen, an audio input device (e.g., a microphone), or the like. The control module 110 is coupled to the input device 102 to receive input from the user of the electronic device 100 via the input device 102 and to facilitate operation of the electronic device 100 in accordance with the received user input. The display device 104 is realized as an electronic display configured to graphically display information or content under control of the control module 110. Depending on the embodiment, the display device 104 may be realized as a liquid crystal display, a light-emitting diode display, an organic light-emitting diode display, a plasma display, or another suitable electronic display. The control module 110 is coupled to the display device 104, and the control module 110 controls the display or rendering of content on the display device 104, as described in greater detail below. The communications arrangement 106 generally represents the hardware, software, firmware, or combinations thereof configured to transmit or receive incoming communications or signals directed to and from the electronic device 100 via one or more communications channels or communications networks in a conventional manner. In this regard, in practice, the communications arrangement 106 may include one or more amplifiers, filters, modulators or demodulators, digital-to-analog converters, analog-to-digital converters, mixers, antennas, and the like. The communications arrangement 106 is coupled to the control module 110, and the communications arrangement 106 and the control module 110 are cooperatively configured to support communications to and from the electronic device 100 in a conventional manner, as will be appreciated in the art.

In an exemplary embodiment, the control module 110 generally represents the hardware, software, firmware, processing logic, or other components of the electronic device 100 configured to support operation of the electronic device 100 and execute various functions or processing tasks described in greater detail below. Depending on the embodiment, the control module 110 may be implemented or realized with a general purpose processor, a microprocessor, a controller, a microcontroller, a state machine, a content addressable memory, an application-specific integrated circuit, a field programmable gate array, any suitable programmable logic device, discrete gate or transistor logic, discrete hardware components, or any combination thereof, designed to perform the functions described herein. Furthermore, the steps of a method or algorithm described in connection with the embodiments disclosed herein may be embodied directly in hardware, in firmware, in a software module executed by the control module 110, or in any practical combination thereof. The memory 108 represents any non-transitory short- or long-term storage medium capable of storing programming instructions for execution by the control module 110, including any sort of random-access memory (RAM), read-only memory (ROM), flash memory, registers, hard disks, removable disks, magnetic or optical mass storage, or the like. The programming instructions, when read and executed by the control module 110, cause the control module 110 to perform certain tasks, operations, functions, and processes described in more detail herein.

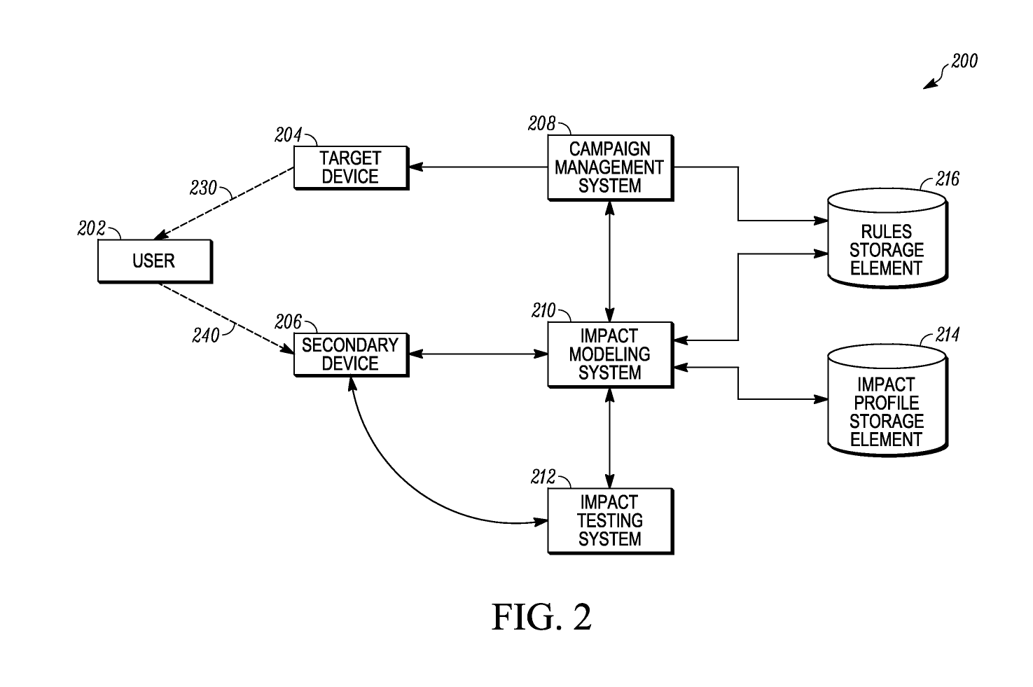

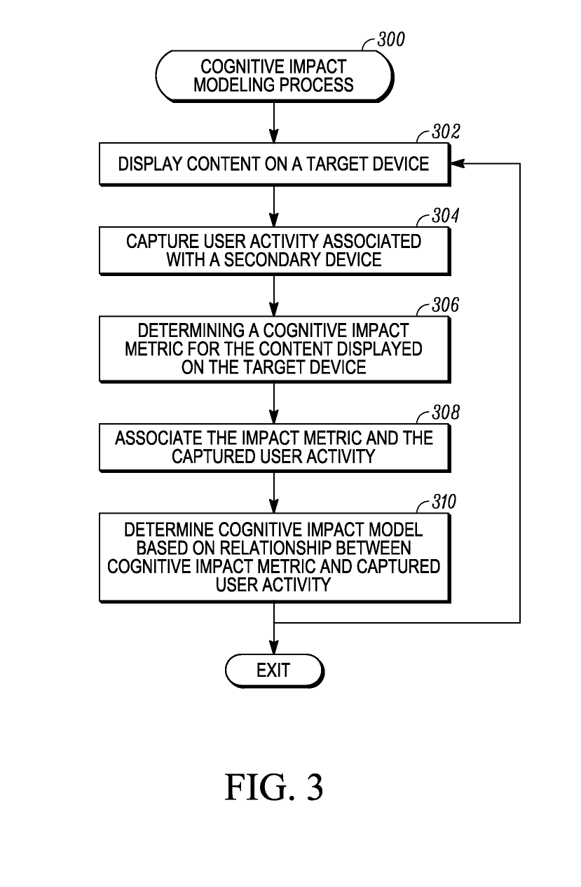

FIG. 2 depicts an exemplary content-management system 200 suitable for implementing the cognitive-impact modeling process 300 described below in the context of FIG. 3 to determine the cognitive impact of content presented to a user 202 (illustrated by arrow 230) using a first electronic device 204 while the user 202 concurrently accesses or otherwise engages a second electronic device 206 (illustrated by arrow 240) and to correlate the user's activity associated with the second electronic device 206 to the cognitive impact the presented content had on the user 202. In addition to the electronic devices 204, 206 that are concurrently viewable or otherwise accessible to the user 202, the content-management system 200 includes, without limitation, a campaign-management system 208, an impact-modeling system 210, an impact-testing system 212, an impact-profile storage element 214, and a testing-rules storage element 216. The elements of the content-management system 200 are communicatively coupled via one or more communications networks (e.g., a cable broadcast network, a satellite broadcast network, a computer network, and the like) and cooperatively configured to support the cognitive-impact modeling process 300, as described in greater detail below.

It should be understood that FIG. 2 is a simplified representation of the content-management system 200 for purposes of explanation and is not intended to limit the scope of the subject matter in any way. In this regard, although the content-management system 200 is described in the context of two electronic devices 204, 206 for ease of explanation, it will be appreciated that in practice, the content-management system 200 is adaptable to support any number of electronic devices that are concurrently accessible or viewable by the user 202. Furthermore, although the campaign-management system 208, the impact-modeling system 210, the impact-testing system 212, the impact-profile storage element 214, and the testing-rules storage element 216 are all depicted as physically distinct or separate elements, in practical embodiments, one or more of the campaign-management system 208, the impact-modeling system 210, the impact-testing system 212, the impact-profile storage element 214, or the testing-rules storage element 216 may be integrated into or otherwise embodied in a single physical component. For convenience, but without limitation, the first electronic device 204 having content provided by the campaign-management system 208 presented thereon is alternatively referred to herein as the target device, and the second electronic device 206 capable of being concurrently accessed or engaged by the user 202 is alternatively referred to herein as the secondary device.

In the illustrated embodiment of FIG. 2, the campaign-management system 208 generally represents a combination of one or more electronic devices, computing systems, hardware, software, firmware, processing logic, or other components that are communicatively coupled to the target device 204 over a communications network. For example, in one or more embodiments, the target device 204 is realized as a television, wherein the campaign-management system 208 is realized as one or more servers configured to present content on or otherwise provide content to the television over a cable or satellite broadcast network or a computer network (e.g., the Internet). In exemplary embodiments, the campaign-management system 208 provides advertising content (or advertisements) to the target device 204 as part of an advertising campaign implemented by or otherwise managed by the campaign-management system 208.

Likewise, the impact-modeling system 210 generally represents a combination of one or more electronic devices, computing systems, hardware, software, firmware, processing logic, or other components that are communicatively coupled to the secondary device 206 and to the campaign-management system 208 over one or more communications networks. For example, in one or more embodiments, the impact-modeling system 210 may be realized as or otherwise implemented by a set-top box (e.g., as a software module, application, agent or daemon that executes on the set-top box) which communicates with the secondary device 206 (e.g., a mobile phone or mobile computer) over a wireless network (e.g., a wireless local area network, a cellular network, Bluetooth, or the like) and which communicates with the campaign-management system 208 over a broadcast network or another computer network. In other embodiments, the impact-modeling system 210 is realized as one or more servers that communicate with the secondary device 206 over a computer network, cellular network, or other communication network. In yet other embodiments, the impact-modeling system 210 is realized as a software module, application, agent, or daemon that executes on the secondary device 206. Similarly, the impact-testing system 212 generally represents a combination of one or more electronic devices, computing systems, hardware, software, firmware, processing logic, or other components that are communicatively coupled to the secondary device 206 and to the impact-modeling system 210 over one or more communications networks. In this regard, in some embodiments, the impact-testing system 212 may be realized as a software module, application, agent, or daemon that executes on the secondary device 206, whereas in other embodiments, the impact-testing system 212 may be realized as or otherwise implemented by a set-top box, a server, or another suitable electronic device communicatively coupled to the secondary device 206.

In the illustrated embodiment, the impact-profile storage element 214 generally represents a data storage element or another repository that is communicatively coupled to the impact-modeling system 210. Depending on the embodiment, the impact-profile storage element 214 may be realized as any non-transitory short- or long-term storage medium capable of storing data, including any suitable combination or arrangement of RAM, ROM, flash memory, registers, hard disks, removable disks, magnetic or optical mass storage, or the like. As described in greater detail below, in an exemplary embodiment, the impact-profile storage element 214 maintains an association between an instance of content presented on or otherwise displayed by the target device 204, captured user activity associated with the secondary device 206, and a metric indicative of the cognitive impact the instance of content had on the user 202 who was engaged in the captured user activity with respect to the secondary device 206 while that instance of content was presented to the user 202 via the target device 204.

Likewise, the testing-rules storage element 216 generally represents a data storage element or another repository that is communicatively coupled to the impact-modeling system 210 and to the campaign-management system 208. Depending on the embodiment, the testing-rules storage element 216 may be realized as any non-transitory short- or long-term storage medium capable of storing data, including any suitable combination or arrangement of RAM, ROM, flash memory, registers, hard disks, removable disks, magnetic or optical mass storage, or the like. As described in greater detail below, in an exemplary embodiment, the testing-rules storage element 216 maintains an association between an instance of content presented on the target device 204 and testing rules defined by the campaign-management system 208 that are to be utilized by the impact-modeling system 210 and the impact-testing system 212 to determine the cognitive impact the instance of content had on the user 202 who was engaged in the captured user activity with respect to the secondary device 206. In this regard, the testing rules may dictate a scheduled amount of time after presentation of the instance of content on the target device 204 for testing the cognitive impact on the user 202, surveys or questions based on the particular instance of content designed to measure or otherwise gauge its cognitive impact, a particular manner or medium for conducting the test, and the like.

Turning now to FIG. 3, in an exemplary embodiment, the content-management system 200 is configured to perform a cognitive-impact modeling process 300 and additional tasks, functions, or operations as described below. The various tasks may be performed by software, hardware, firmware, or any combination thereof. For illustrative purposes, the following description may refer to elements mentioned above in connection with FIGS. 1 and 2. In practice, the tasks, functions, and operations may be performed by different elements of the described system, such as the target device 204, the secondary device 206, the campaign-management system 208, the impact-modeling system 210, or the impact-testing system 212. It should be appreciated that any number of additional or alternative tasks may be included and may be incorporated into a more comprehensive procedure or process having additional functionality not described in detail herein.

Referring to FIG. 3, and with continued reference to FIGS. 1 and 2, in an exemplary embodiment, the cognitive-impact modeling process 300 initializes or otherwise begins by presenting or otherwise displaying content on a first device (task 302). In this regard, the campaign-management system 208 provides content, such as an advertisement or other advertising content, to the target device 204 via a communications network for display on the target device 204 (e.g., on the target device's display device 104). For example, the target device 204 may be receiving and displaying entertainment content, such as a television program, movie, or the like, wherein the campaign-management system 208 receives notification of ad points within the entertainment content and provides advertising content for display on the target device 204 within the entertainment content.

In an exemplary embodiment, the cognitive-impact modeling process 300 automatically captures, records, or otherwise obtains user activity associated with or otherwise pertaining to a second device while the content is presented by the first device (task 304). In this regard, the impact-modeling system 210 automatically captures or otherwise records the activity by the user 202 performed on the secondary device 206 while content provided by the campaign-management system 208 is displayed by the target device 204. In an exemplary embodiment, the impact-modeling system 210 also captures the context of the user activity. In other words, the captured user activity may also include information pertaining to the context in which the captured user activity occurred in, such as, for example, the geographic location of the user 202 or the secondary device 206, the type of secondary device 206 being utilized by the user 202 (e.g., whether the secondary device 206 is a mobile phone, laptop computer, an electronic book reader, or the like), the number of other users or devices proximate to the user 202 or secondary device 206 (e.g., by performing proximity analysis using Bluetooth or another suitable technology), the current mood of the user 202 (e.g., by performing sentiment analysis or the like), or other context information. In accordance with one or more embodiments, prior to displaying advertising content on the target device 204, the campaign-management system 208 notifies the impact-modeling system 210 of the upcoming advertising content to initiate the capture of the user activity pertaining to the secondary device 206 while the advertising content is displayed by the target device 204. The campaign-management system 208 may also provide the impact-modeling system 210 with additional identifying information associated with the advertising content, such as, for example, an identifier corresponding to a particular advertisement, a category (or type) of advertisement (e.g., food, beverage, sports, entertainment, leisure, travel, and the like) for the advertisement, a style of advertisement (e.g., textual, graphical, video, or the like), a duration of the advertisement, an entity associated with the advertisement (e.g., the brand, product, or company that is the source of the advertisement), or other attributes or characteristics associated with the advertisement.

In an exemplary embodiment, in response to the notification from the campaign-management system 208, the impact-modeling system 210 automatically captures user activity on the secondary device 206 that overlaps or otherwise coincides with the content being presented by the target device 204. For example, the impact-modeling system 210 may monitor and capture user activity associated with the secondary device 206 for a window of time that overlaps, at least in part, the window of time during which the advertising content is displayed by the target device 204. In this regard, at least a portion of the monitoring window (the window of time during which the user activity being performed with respect to the secondary device 206 is captured by the impact-modeling system 210) is concurrent or contemporaneous with the advertising window (the window of time during which the advertising content provided by campaign-management system 208 is displayed by the target device 204). For example, the advertising content may be displayed on the target device 204 for a thirty-second window of time, wherein the impact-modeling system 210 captures user activity for a window of time that is greater than thirty seconds long and begins before and ends after the thirty-second window corresponding to the advertising content, such that the monitoring window overlaps or otherwise encompasses the entire advertising window. In various embodiments, the monitoring window may overlap only a portion of the advertising window, and the duration of the monitoring window may be greater or less than the duration of the advertising window.

Still referring to FIGS. 1 through 3, in an exemplary embodiment, the user activity captured by the impact-modeling system 210 includes any user input received by the secondary device 206 during the monitoring window along with the services or content being provided or displayed by the secondary device 206 during the monitoring window. For example, the impact-modeling system 210 may capture the software application or service being utilized by the user 202 or executed by the secondary device 206 (e.g., a web browser, an e-mail client, or the like) along with the contents or context of the software application (e.g., the web address or uniform resource locator (URL) for a web browser, the display being presented by the e-mail client, or the like). In exemplary embodiments, the impact-modeling system 210 also captures other contextual information pertaining to the secondary device 206 or to the user 202 during the monitoring window. Additionally, the impact-modeling system 210 captures the user inputs received by the secondary device 206, such as the input text provided by the user 202, the pattern or sequence of mouse-clicks, keystrokes, gestures, or other inputs, and the like. In accordance with one or more embodiments, based on the user input received by the secondary device 206 or the services or content being provided or displayed by the secondary device 206, the impact-modeling system 210 may identify or otherwise classify the captured user activity as a defined type (or class) of user activity, such as, for example, web browsing, social networking, e-mailing, and the like. It will be appreciated that there are numerous manners in which the captured user activity may be classified, and in practice, the level of classification will vary depending on the needs of a particular application. For example, in some embodiments, the captured user activity may be classified in a relatively generic manner (e.g., web browsing), while in other embodiments, the captured user activity may be classified in a relatively specific manner (e.g., sharing using a social networking site).

In an exemplary embodiment, the impact-modeling system 210 stores, in the impact-profile storage element 214, the identified type of captured user activity and any obtained context information along with identifying information for the user 202 (e.g., a user identifier, a subscriber identifier, or the like) and a device identifier for the secondary device 206. Additionally, the impact-modeling system 210 stores, in the impact-profile storage element 214, the identifying information associated with the advertising content provided by the campaign-management system 208 (e.g., the identifier for the advertisement, the category of advertisement, and the like). In this regard, the impact-profile storage element 214 maintains an association between the type of captured user activity from the secondary device 206, the context of the captured user activity, the user 202 associated with the captured user activity, and the advertising content provided by the campaign-management system 208 and displayed by the target device 204 concurrently to the captured user activity (or a portion thereof).

In an exemplary embodiment, the cognitive-impact modeling process 300 continues by automatically determining an impact metric indicative of the relative cognitive effectiveness of the content presented by a target device on the user associated with the user activity captured from a secondary device (task 306). In accordance with one embodiment, the impact-modeling system 210 automatically determines the cognitive impact of the content presented on the target device 204 based on the content of the captured user activity. For example, the campaign-management system 208 may provide a number of web addresses or URLs (either directly to the impact-modeling system 210 or via the testing-rules storage element 216) associated with an advertisement presented on the target device 204 (e.g., URLs presented during the advertisement), wherein the impact-modeling system 210 determines a metric indicating that the advertisement had a successful cognitive impact when the captured user activity corresponds to the user 202 directing a web browser executing on the secondary device 206 to one of the web addresses provided by the campaign-management system 208. In other embodiments, the campaign-management system 208 may provide a number of keywords associated with an advertisement presented on the target device 204, wherein the impact-modeling system 210 determines a metric indicating that the advertisement had a successful cognitive impact when the captured user activity (e.g., part of a textual user input captured during the monitoring window) includes one or more of the keywords, for example, if the user 202 is communicating something about the advertisement to one or more other individuals using a social networking service, a chat (or instant messaging) service, via e-mail, or the like. In yet other embodiments, the impact-modeling system 210 may automatically determine the cognitive impact of the content presented on the target device 204 based on changes in captured user activity during the advertising window. For example, when the monitoring window begins before or ends after the advertising window, the impact-modeling system 210 may determine a cognitive-impact metric based on changes in the frequency or cadence of user input during the advertising window relative to the user input captured before or after the advertising window.

In accordance with one or more embodiments, the impact-modeling system 210 and the impact-testing system 212 are cooperatively configured to automatically test, measure, or otherwise assess the cognitive impact of content presented on the target device 204 in accordance with testing rules provided by the campaign-management system 208. As described above, in exemplary embodiments, the campaign-management system 208 defines a number of testing rules and stores the testing rules in the testing-rules storage element 216. For example, for an individual advertisement (or advertisement category), the campaign-management system 208 may prescribe a particular amount of elapsed time (or delay) after presentation of the advertisement on the target device 204 for when the cognitive-impact test should be conducted, a particular manner or medium for conducting the cognitive-impact test, and one or more stimuli (e.g., questions, games, activities, tasks, or the like) based on the contents of the advertisement that are designed to gauge the cognitive impact of the advertisement based on user responses to the stimulus. After capturing user activity associated with the secondary device 206 during an advertisement presented on the target device 204, the impact-modeling system 210 accesses the testing-rules storage element 216 and obtains the appropriate testing rules for that advertisement based on the identifying information for the advertisement provided by the campaign-management system 208.

In exemplary embodiments, the impact-modeling system 210 automatically provisions or otherwise configures the impact-testing system 212 to perform the appropriate cognitive test for that advertisement (e.g., by presenting the survey questions or other stimuli associated with that advertisement on the secondary device 206 or another electronic device) at the specified amount of time after the advertisement is presented on the target device 204. In this regard, the impact-testing system 212 automatically queries the user 202, via the secondary device 206 or another electronic device, by automatically presenting the survey questions provided by the campaign-management system 208 in the manner specified by the campaign-management system 208. For example, in some embodiments, the testing rules may dictate that the test is to be conducted within a web browser when the user 202 navigates the web browser on the secondary device 206 to a particular web address or URL (e.g., a URL associated with the campaign-management system 208). In this regard, when the user 202 directs the web browser to that web address the scheduled amount of time after the content was presented by the target device 204, the impact-testing system 212 automatically presents the survey questions on the secondary device 206 within the web browser. In other embodiments, the testing rules may dictate that the test be conducted independent of other applications on the secondary device 206, in which case the impact-testing system 212 may function as a temporary standalone application on the secondary device 206 that automatically presents the survey questions on the secondary device 206 the scheduled amount of time after the content is presented by the target device 204. In some embodiments, the testing rules may dictate that the test be conducted on the secondary device 206 when the user 202 is engaged in the same type of activity as the activity on the secondary device 206 that was captured when the content was presented on the target device 204. For example, if the user 202 was engaged in emailing on the secondary device 206 while advertising content was presented on the target device 204, the impact-testing system 212 may automatically query the user 202 when the user 202 subsequently accesses an email client on the secondary device 206 at a particular amount of time after the content is presented by the target device 204. It should be noted that although the subject matter is described herein in the context of performing the testing on the secondary device 206, in other embodiments, the cognitive-impact testing may be performed using the target device 204 or another electronic device communicatively coupled to the impact-testing system 212 and accessed by the user 202.

In an exemplary embodiment, the impact-testing system 212 receives the user's responses to the stimulus presented on the secondary device 206 (e.g., the user input or answers received in response to presenting the survey questions) and provides the user responses to the impact-modeling system 210. Based on the user response to the cognitive-impact test, the impact-modeling system 210 calculates or otherwise determines a metric indicative of the cognitive impact of the advertisement on the user 202. For example, the content-management system 208 may store, in the testing-rules storage element 216, the possible responses to the stimuli (e.g., answers to the survey questions) along with an indication of how the possible responses correlate to the cognitive impact, wherein the impact-modeling system 210 determines the cognitive-impact metric based on the user response and on the corresponding cognitive-impact information provided by the content-management system 208 in the testing-rules storage element 216.

Still referring to FIG. 3, after determining a cognitive-impact metric for the content presented on the target device, the cognitive-impact modeling process 300 continues by associating the cognitive-impact metric with the captured user activity and by correlating the cognitive-impact metric with the captured user activity by determining a cognitive-impact model for the user based on the relationship between the cognitive-impact metric and the captured user activity (tasks 308, 310). In this regard, the cognitive-impact modeling process 300 utilizes the association between the captured user activity and its associated user to create a user-specific cognitive-impact model.

In an exemplary embodiment, the impact-modeling system 210 stores the cognitive-impact metric in the impact-profile storage element 214 in association with the captured user activity or provides the association of cognitive-impact metrics and captured user activity to the campaign-management system 208. The campaign-management system 208 or the impact-modeling system 210 utilizes stored associations of cognitive-impact metrics and captured user activities to develop a predictive model of the likely cognitive impact on the user 202 of content subsequently presented on the target device 204 with respect to activity associated with the second device 206 being performed by the user 202. For example, a machine learning model (or machine learning algorithm), an artificial neural network, or another suitable modeling technique may be applied to the cognitive-impact metrics and captured user activities to obtain a deterministic model of the cognitive effectiveness of content presented on a target device with respect to different types of activities performed by the user 202 on one or more secondary devices. Additionally, the cognitive-impact model may utilize the association between the presented content and the captured user activity maintained by the impact-profile storage element 214 to model the cognitive impact across different attributes or characteristics of the content presented on the target device (e.g., the type of advertisement, or the like). The cognitive-impact modeling process 300 may repeat as desired throughout operation of the content-management system 200 to present multiple instances of content (e.g., advertisements) to any number of users on any number of target devices, capture concurrent user activities associated with secondary devices, determine cognitive-impact metrics for the various instances of content and corresponding captured user activities, associate the cognitive-impact metric and the captured user activity for each instance of content presented on a target device, and continuously and dynamically update cognitive-impact models.

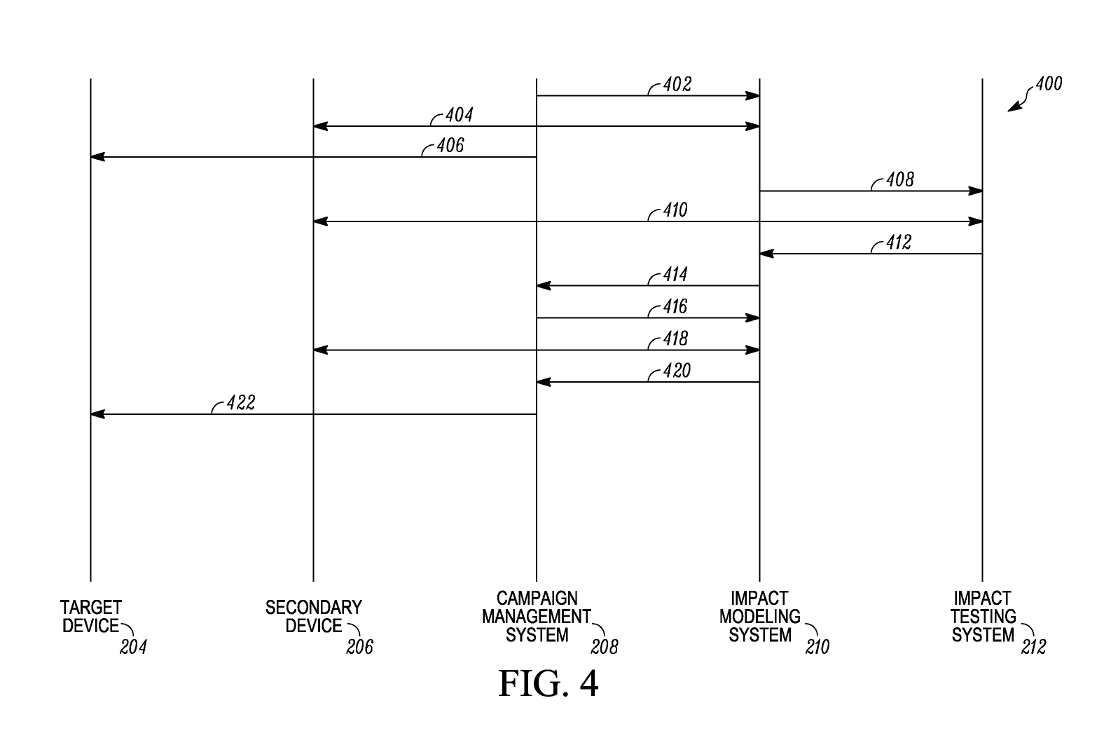

As described in greater detail below in the context of FIG. 4, in accordance with one or more embodiments, the campaign-management system 208 obtains, via the impact-modeling system 210, information pertaining to instantaneous or real-time user activity associated with a secondary device 206 prior to presenting content on the target device 204 and, based on the obtained type of user activity currently associated with the secondary device 206, utilizes the cognitive-impact model for the user 202 of the secondary device 206 to determine the type of content to be presented on the target device 204 that is likely to have the greatest cognitive impact on the user 202. In other embodiments, the cognitive-impact model may be utilized for purposes of dynamically pricing content presented on a target device 204 based on the likely cognitive impact of that content on the user 202 by applying the cognitive-impact model for the user 202 to the type of content being presented and the instantaneous or real-time activity being performed by the user 202 on the secondary device 206.

FIG. 4 illustrates an exemplary sequence 400 of communications within the content-management system 200 in accordance with an exemplary embodiment of the cognitive-impact modeling process 300. Referring to FIG. 4, and with continued reference to FIGS. 1 through 3, the sequence 400 begins when the campaign-management system 208 notifies 402 or otherwise signals the impact-modeling system 210 to capture user activity associated with the secondary device 206 when content provided by the campaign-management system 208 is presented on the target device 204. For example, at some threshold amount of time before an advertisement is displayed on the target device 204, the campaign-management system 208 may notify the impact-modeling system 210 of the scheduled time for airing the advertisement, such that the impact-modeling system 210 is capable of capturing or otherwise recording user activity associated with the secondary device 206 prior to presentation of the advertisement on the target device 204.

After receiving notification 402 from the campaign-management system 208, in an exemplary embodiment, the impact-modeling system 210 automatically captures 404 user activity associated with the secondary device 206 at or around the same time as content provided 406 by the campaign-management system 208 is displayed on the target device 204. In this regard, the impact-modeling system 210 captures 404, during a window of time, any user input received by the secondary device 206 during that window of time along with information pertaining to any services or content being provided or displayed by the secondary device 206 and any other contextual information for the secondary device 206 or the user 202. For example, the impact-modeling system 210 may capture the software application being utilized by the user 202 on the secondary device 206, the contents or context of the software application, and any user inputs (e.g., sequences or patterns of keystrokes, mouse-clicks, gestures, and the like) received by that software application. After capturing 404 the user activity, the impact-modeling system 210 stores, in the impact-profile storage element 214, the identified type of captured user activity along with identifying information for the user 202, a device identifier for the secondary device 206, and identifying information provided 402 by the campaign-management system 208 that pertains to the content provided 406 to be presented by the target device 204. In exemplary embodiments, the impact-modeling system 210 captures 404 the user activity on the secondary device 206 during a monitoring window that begins at the same time as (or some threshold amount of time before) an advertising window for an advertisement that is provided 406 by the campaign-management system 208 and presented on the target device 204. As discussed above, depending on the embodiment, the duration of the monitoring window may be the same as the advertising window, or the monitoring window may be greater than or less than the duration of the advertising window, provided that at least some portion of the monitoring window overlaps the advertising window to capture user activity associated with the secondary device 206 that occurs concurrent to the presentation of the advertisement on the target device 204.

In the illustrated embodiment, after capturing 406 user activity on the secondary device 206 and updating the impact-profile storage element 214, the impact-modeling system 210 accesses the testing-rules storage element 216 to obtain the testing rules defined by the campaign-management system 208 for the content provided 406 to the target device 204, and based on the testing rules, the impact-modeling system 210 automatically provisions 408 or otherwise configures the impact-testing system 212 to conduct the desired cognitive-impact testing. In this regard, based on the time that the advertisement was displayed and a scheduled delay time specified by the testing rules for the advertisement, the impact-modeling system 210 may instruct or otherwise configure the impact-testing system 212 to conduct the cognitive-impact test at the appropriate time. Furthermore, the impact-modeling system 210 may provide the impact-testing system 212 with the appropriate surveys, questions, or other stimuli for determining the cognitive impact of the particular instance of content and configure the impact-testing system 212 to conduct the testing in a particular manner prescribed by the campaign-management system 208.

After being provisioned 408 or otherwise configured by the impact-modeling system 210, the impact-testing system 212 automatically conducts 410 the cognitive-impact test on the secondary device 206 at the desired time after the advertisement was provided 406 to the target device 204, receives user input indicative of the user's response (or answers) to the stimuli provided 408 by the impact-modeling system 210, and provides 412 the user's response to the impact-modeling system 210. As discussed above, the impact-modeling system 210 calculates or otherwise determines a metric indicative of the cognitive impact of the advertisement based on the user response to the cognitive-impact test and associates the cognitive-impact metric with the captured user activity and the advertisement in the impact-profile storage element 214. The impact-modeling system 210 also provides 414 the campaign-management system 208 with the cognitive-impact metric and its associated captured user activity (or a cognitive-impact model based thereon). In some embodiments, based on the relationship between the cognitive-impact metric and the captured user activity, the campaign-management system 208 may modify the testing rules in the testing-rules storage element 216 to alter the cognitive-impact test for subsequent instances of the content provided to the target device 204.

As described above, in exemplary embodiments, based on the relationship between the cognitive-impact metric and the captured user activity, the campaign-management system 208 modifies upcoming content provided to the target device 204 by selecting content that is most likely to have a cognitive impact on the user 202 based on the cognitive-impact model. For example, prior to providing additional content to the target device 204, the campaign-management system 208 notifies 416 or otherwise signals the impact-modeling system 210 to capture the current user activity associated with the secondary device 206. In response to receiving notification 416 from the campaign-management system 208, the impact-modeling system 210 automatically captures 418 the instantaneous activity being performed on the secondary device 206 by the user 202, determines the type or content of the user activity associated with the secondary device 206, and provides 420 the type or content of user activity to the campaign-management system 208. Based on the current user activity associated with the secondary device 206 obtained 420 from the impact-modeling system 210 and the cognitive-impact model for the user 202 of the secondary device 206, the campaign-management system 208 selects and provides 422 content for presentation on the target device 204 that is most likely to have a desired cognitive impact on the user 202 based on the activity associated with the secondary device 206 that the user 202 is currently engaged in. For example, if the user 202 is currently performing web browsing on the secondary device 206 and a particular type of advertising, such as travel-related advertising, is most likely to have a positive cognitive impact, then the campaign-management system 208 may provide 422 a travel advertisement that is displayed on the target device 204 while the user 202 is likely to be performing web browsing on the secondary device 206. In this manner, content provided to the target device 204 may be dynamically selected in real-time based on the user activity on the secondary device 206. Although not illustrated in the sequence 400 of FIG. 4, the cognitive-impact modeling process 300 may continue with the impact-modeling system 210 capturing concurrent user activity associated with secondary device 206 while the travel advertisement was displayed by the target device 204 (e.g., web browsing), determining a cognitive-impact metric for the travel advertisement, associating the cognitive-impact metric for the travel advertisement and the captured user activity, and updating the cognitive-impact model based on the cognitive-impact metric for the travel advertisement. In this manner, the cognitive-impact model for the user 202 is dynamically updated to more accurately predict the likely cognitive impact of content subsequently presented on the target device 204 while the user 202 is concurrently engaged in activity on or otherwise associated with the secondary device 206.

For the sake of brevity, conventional techniques related to communications networks, communications protocols or signaling, machine learning or predictive modeling, surveying or cognitive assessments, and other functional aspects of the systems (and the individual operating components of the systems) may not be described in detail herein. Furthermore, the connecting lines shown in the various figures contained herein are intended to represent example functional relationships or physical couplings between the various elements. It should be noted that many alternative or additional functional relationships or physical connections may be present in a practical embodiment.

Additionally, the subject matter may be described herein in terms of functional or logical block components and various processing steps. It should be appreciated that such block components may be realized by any number of hardware, software, or firmware components configured to perform the specified functions. For example, an embodiment of a system or a component may employ various integrated circuit components, e.g., memory elements, digital signal processing elements, logic elements, look-up tables, or the like, which may carry out a variety of functions under the control of one or more microprocessors or other control devices.

The foregoing description refers to elements or nodes or features being “coupled” together. As used herein, unless expressly stated otherwise, “coupled” means that one element, node, or feature is directly or indirectly joined to (or directly or indirectly communicates with) another element, node, or feature, and not necessarily mechanically. Thus, although the drawings may depict one exemplary arrangement of elements, additional intervening elements, devices, features, or components may be present in an embodiment of the depicted subject matter.

While at least one example embodiment has been presented in the foregoing detailed description, it should be appreciated that a vast number of variations exist. It should also be appreciated that the example embodiment or embodiments described herein are not intended to limit the scope, applicability, or configuration of the claimed subject matter in any way. Rather, the foregoing detailed description will provide those skilled in the art with a convenient road map for implementing the described embodiment or embodiments. It should be understood that various changes can be made in the function and arrangement of elements without departing from the scope defined by the claims, which includes known equivalents and foreseeable equivalents at the time of filing of this patent application.

We claim:

1. A method of modeling impact of content displayed on a first device on a user engaged with a second device, the method comprising:
obtaining user activity associated with the second device when the content is displayed on the first device;
determining an impact metric for the content; and
correlating the impact metric with the user activity for the user.

2. The method of claim 1 wherein correlating the impact metric with the user activity comprises determining a cognitive-impact model for the user based on the impact metric and the user activity.

3. The method of claim 2 further comprising:
automatically obtaining second user activity associated with the second device after determining the cognitive-impact model; and
displaying second content on the first device based on the second user activity, wherein the second content is selected based on a likely impact determined using the cognitive-impact model for the user.

4. The method of claim 1 wherein obtaining the user activity comprises automatically capturing activity on the second device while the content is displayed on the first device.

5. The method of claim 1 wherein determining the impact metric comprises:
automatically conducting an impact test for the content; and
determining the impact metric based on input from the user responsive to the impact test.

6. The method of claim 5 wherein automatically conducting the impact test comprises:
presenting, on the second device, a stimulus pertaining to the content; and
receiving, from the second device, a user response to the stimulus, the impact metric being determined based on the user response.

7. The method of claim 1 wherein determining the impact metric comprises determining the impact metric based on the user activity.

8. The method of claim 1:
wherein the content is displayed on the first device during a first window of time;
wherein obtaining the user activity comprises obtaining the user activity during a second window of time; and
wherein a portion of the second window overlaps a portion of the first window.

9. The method of claim 1:
wherein the content comprises an advertisement displayed on the first device; and
wherein obtaining the user activity comprises automatically capturing the user activity on the second device during the advertisement.

10. A system comprising:
a campaign-management system to provide content displayed on a first device; and
an impact-modeling system to capture user activity on a second device when the content is displayed on the first device, to determine an impact metric for the content, and to correlate the impact metric to the user activity for the user.

11. The system of claim 10 wherein the impact-modeling system is coupled to the campaign-management system and configured to capture the user activity in response to receiving notification of the content being displayed on the first device from the campaign-management system.

12. The system of claim 10:
further comprising an impact-testing system coupled to the impact-modeling system;
wherein the impact-modeling system is configured to:
provision the impact-testing system to automatically conduct an impact test after the content is displayed on the first device; and
determine the impact metric based on a user response to the impact test; and
wherein the impact-testing system is configured to:
automatically conduct the impact test;
receive the user response to the impact test; and
provide the user response to the impact-modeling system.

13. The system of claim 12:
further comprising a data storage element coupled to the campaign-management system and to the impact-modeling system;
wherein the campaign-management system is configured to store testing rules for the impact test in the data storage element, the testing rules including a first time; and
wherein the impact-modeling system is configured to:
obtain the testing rules from the data storage element; and
provision the impact-testing system to automatically conduct the impact test the first time after the content is displayed on the first device.

14. The system of claim 13:
wherein the testing rules include a question based on the content; and
wherein the impact-modeling system is configured to provision the impact-testing system to automatically present the question to a user associated with the user activity the first time after the content is displayed on the first device, the user providing the user response in response to the impact-testing system presenting the question to the user.

15. The system of claim 12 wherein the impact-testing system is coupled to the second device and is configured to:
automatically conduct the impact test by automatically presenting, on the second device, a stimulus based on the content displayed on the first device; and
after presenting the stimulus, receive the user response from the second device, the user response being provided to the second device in response to the stimulus.

16. A method of relating cognitive impact of content on a target device on a user engaged with a secondary device, the method comprising:
automatically capturing user activity on the secondary device when an advertisement is displayed on the target device;
automatically determining a cognitive-impact metric for the advertisement; and
determining a cognitive-impact model based on a relationship between the cognitive-impact metric and the user activity.

17. The method of claim 16 wherein automatically determining the cognitive-impact metric comprises:
automatically conducting an impact test for the advertisement on the secondary device a predetermined time after the advertisement is displayed on the target device;
receiving, via the secondary device, a user response to the impact test; and
determining the cognitive-impact metric for the advertisement based on the user response.

18. The method of claim 17:
further comprising obtaining testing rules for the advertisement from a campaign-management system providing the advertisement, the testing rules including a scheduled time for conducting the impact test;
wherein the impact test is automatically conducted the scheduled time after the advertisement is displayed.

19. The method of claim 16:
wherein the advertisement is displayed during an advertising window; and
wherein automatically capturing the user activity comprises:
receiving notification of the advertising window; and
automatically capturing the user activity in a monitoring window in response to the notification, wherein at least a portion of the monitoring window is concurrent with the advertising window.

20. The method of claim 16:
wherein the user activity includes an input from the user received by the secondary device; and
wherein automatically determining the cognitive-impact metric comprises determining the cognitive-impact metric based on the input.
